(19) United States
(12) Patent Application Publication
(10) Pub. No.: US 2021/0376334 A1
(43) Pub. Date: Dec. 2, 2021

(54) METAL-AIR BATTERY

(71) Applicant: SHARP KABUSHIKI KAISHA, Osaka (JP)

(72) Inventors: HIROYUKI HIRAKAWA, Osaka (JP); HIROYUKI YAMAJI, Osaka (JP); MAI TAKASAKI, Osaka (JP); FUMITOSHI SUGINO, Osaka (JP); HIROTAKA MIZUHATA, Osaka (JP); SHINOBU TAKENAKA, Osaka (JP)

(21) Appl. No.: 17/245,655

(22) Filed: Apr. 30, 2021

(30) Foreign Application Priority Data
May 28, 2020 (JP) 2020-093319

(51) Int. Cl. H01M 4/78; H01M 12/08; H01M 12/02

(52) U.S. Cl. CPC H01M 4/78; H01M 2004/027; H01M 12/02; H01M 12/08

(57) ABSTRACT

A metal-air battery 1 includes an air electrode and a negative electrode. The negative electrode includes a collector carrying an active material thereon. The collector is formed by bending a plate with through holes in a wavy way, and a bending height of the collector in a thickness direction of the negative electrode is larger than a thickness of the plate.

### BACKGROUND OF THE INVENTION

### Field of the Invention

The present invention relates to a metal-air battery including an air electrode and a negative electrode.

### Description of the Background Art

In recent years, a variety of batteries using a chemical reaction of a metal for an electrode have been practically used, and one of which is a metal-air battery. The metal-air battery is provided with an air electrode (positive electrode) and a fuel electrode (negative electrode), which extracts and uses electric energy obtained through an electrochemical reaction process in which metals such as zinc, ferrous, magnesium, aluminum, sodium, calcium, lithium, etc. changes into metal oxides. There is a case where the metal-air battery uses the negative electrode carrying zinc oxide being an active material onto a collector made of a metal.

Meanwhile, there was the case where the negative electrode including the collector is deformed by internal stress caused by a load when stacking the negative electrodes or a variation of the environmental temperature, etc. A performance of the battery was reduced because such deformation causes a resistance to increase. Therefore, a method of decreasing deformation of the collector due to stress has been studied (see Japanese Patent Laid-open Publication No. 2014-038823, for example).

Japanese Unexamined Patent Application Publication No. 2014-038823 discloses a collector for a solid oxide fuel cell including: a large number of one direction support bodies having length parts extended in one direction; a large number of the other direction support bodies having length parts extended in the other direction different from these one direction support bodies; a large number of pores surrounded by the one direction support bodies and the other direction support bodies arranged to cross each other; and cut parts being provided with in the support bodies. Although the aforementioned collector for a solid oxide fuel cell makes an effort to minimize deformation due to stress by providing the support bodies with cut parts, deformation under increased stress cannot be avoided because increasing a strength of the collector itself is not considered.

In a metal-air battery as a secondary battery, when zinc acid ions are eluted from a negative electrode in which zinc oxide is carried on a collector made of an etched metal, isolated particles of zinc oxide produced by partial heterogeneous dissolution would be desorbed from the collector. Because such the zinc oxide particles sink in downward the battery by gravity, a concentration of zinc oxide ions around there is locally increased, so that a non-uniform battery reaction occurs.

Furthermore, in the negative electrode having a collector made of an etched metal, when zinc is deposited via the zinc oxide ions, while deposition of zinc progresses over the entire surface of the negative electrode, dendrite in which zinc partially grows and protrudes is formed. Dendrites is desorbed associated with deformation or breakage by external vibrations or even by force due to fluctuations in an electrolytic solution because the dendrites have no mechanical strength. Such zinc particles sink in downward the battery by gravity. Zinc incapable of exchanging electrons with the collector becomes zinc that does not contribute to the battery reaction.

Furthermore, in the case of a plate-shaped negative electrode in which zinc oxide is carried on a collector made of an etched metal, a zinc oxide layer is formed about 0.5 to several millimeters in thickness. In the zinc-air battery mainly characterized in a large weight energy density, it is a trend that a quantity of zinc oxide to be mounted is increased, whereby it is also trend that a thickness of the zinc oxide layer is increased accordingly. If the zinc oxide layer is about several millimeters in thickness, a distance between the zinc oxide layer and the collector becomes longer, so that the uniformity of electron exchange is also spoiled. Therefore, a current distribution in the active material becomes non-uniform, a significant deviation of zinc deposition behavior likely occurs during charging, and it causes the active material to perform a shape change.

The present invention is made to solve the above described problems, and an object of the present invention is to provide a metal-air battery capable of suppressing deformation of the negative electrode itself.

### SUMMARY OF THE INVENTION

A metal-air battery according to the present invention includes an air electrode and a negative electrode, wherein the negative electrode includes a collector carrying an active material thereon, the collector is formed by bending a plate with through holes in a wavy way, and a bending height of the collector in a thickness direction of the negative electrode is larger than a thickness of the plate.

In some aspect of the metal-air battery according to the present invention, vertices of the collector, which protrude in the thickness direction, may be formed as curved surfaces.

In some aspect of the metal-air battery according to the present invention, the negative electrode may include two collectors regularly stacked.

In some aspect of the metal-air battery according to the present invention, a wave line direction of one collector and a wave line direction of another collector may cross with each other.

In some aspect of the metal-air battery according to the present invention, directions of the wave lines in the two collectors may be arranged in such a way that the respective vertices protruding from one collector to another collector are aligned with each other.

In some aspect of the metal-air battery according to the present invention, the two collectors may be spaced apart from each other.

In some aspect of the metal-air battery according to the present invention, the two collectors may contact with each other.

In some aspect of the present invention, the metal-air battery may include a charging electrode.

According to the present invention, because a collector is of a wavy shape structure, deformation of the negative electrode itself is suppressed while flexure during a battery reaction is suppressed, and thus it is possible to obtain stable battery characteristics.

### BRIEF DESCRIPTION OF DRAWINGS

FIG. 1 is a schematic cross-sectional view illustrating a metal-air battery according to the first embodiment of the present invention.

FIG. 2 is an enlarged plan view illustrating a collector of a negative electrode.

FIG. 3 is a schematic perspective view of the collector illustrated in FIG. 2.

FIG. 4 is a schematic cross-sectional view of the collector illustrated in FIG. 2.

FIG. 5 is a schematic cross-sectional view of a negative electrode of a metal-air battery according to a second embodiment of the present invention.

FIG. 6 is a schematic plan view of the negative electrode illustrated in FIG. 5.

FIG. 7 is a schematic cross-sectional view of a negative electrode of a metal-air battery according to a third embodiment of the present invention.

FIG. 8 is a schematic plan view of the negative electrode illustrated in FIG. 7.

FIG. 9 is a schematic explanatory view illustrating a method of measuring a deformation quantity of a negative electrode during a manufacturing process thereof.

FIG. 10 is a graph showing discharge characteristics of the first embodiment and a comparative example.

FIG. 11 is a graph showing discharge characteristics of the first embodiment and the third embodiment.

FIG. 12 is a graph showing discharge characteristics of the second embodiment and the third embodiment.

### DESCRIPTION OF THE PREFERRED EMBODIMENTS

### First Embodiment

Now, a metal-air battery according to the first embodiment of the present invention will be described below with reference to the drawings.

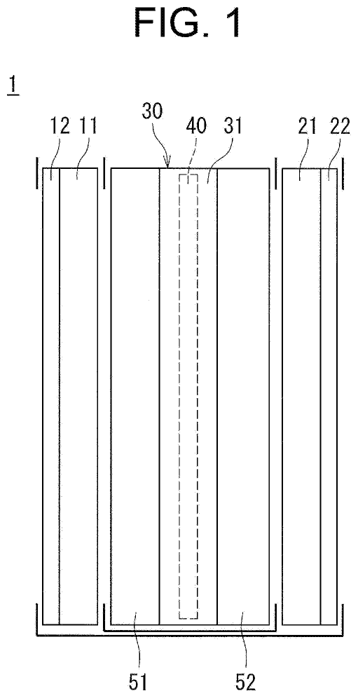

FIG. 1 is a schematic cross-sectional view illustrating a metal-air battery according to the first embodiment of the present invention.

A metal-air battery 1 according to the first embodiment of the present invention is a three-pole metal-air secondary battery, which is configured such that a negative electrode 30 is sandwiched between a charging electrode 11 and an air electrode 21. The metal-air battery 1 may be, for example, a zinc-air battery, a lithium-air battery, a sodium-air battery, a calcium-air battery, a magnesium-air battery, an aluminum-air battery, a ferrous-air battery, etc. The charging electrode 11 and the air electrode 21 each face an inner surface of the exterior of the metal-air battery 1 through water repellent films (i.e., a charging electrode side water repellent film 12 and an air electrode side water repellent film 22), and the exterior of the metal-air battery 1 is configured to provide corresponding positions of the charging electrode 11 and the air electrode 21 with openings to allow only air to pass therethrough.

The air electrode 21 has an air electrode catalyst and may consist of a porous electrode to be a discharge positive electrode. The air electrode side water repellent film 22 may consist of a water repellent porous sheet, for example, PTFE (polytetrafluoroethylene), PE (polyethylene), etc. In an example where an alkaline aqueous solution is used as an electrolytic solution, a discharge reaction, in which water supplied from the electrolytic solution, oxygen gas supplied from the atmosphere, and electrons react on the air electrode catalyst so that hydroxide ions are generated, occurs in the air electrode 21.

The charging electrode 11 may consist of a porous electrode made of a material having electron conductivity. In an example where the alkaline aqueous solution is used as the electrolytic solution, a charging reaction, in which oxygen, water, and electrons are generated from the hydroxide ions, occurs in the charging electrode 11.

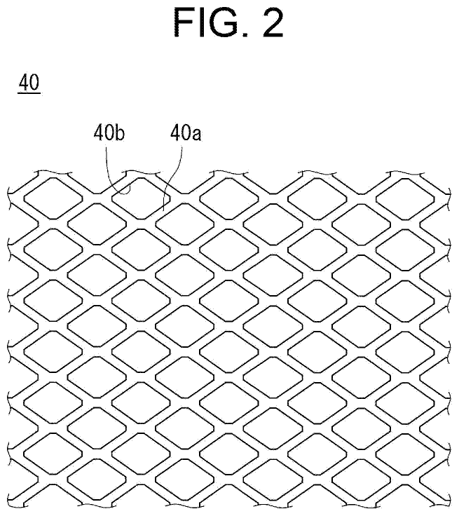

The negative electrode 30 includes a collector 40 carrying an active material 31 thereon. The detailed configuration and a manufacturing method of the negative electrode 30 will be described below with reference to FIGS. 2 through 4.

A surface on the charging electrode 11 side of the negative electrode 30 is covered with a charging electrode side separator 51, and a surface on the air electrode 21 side of the negative electrode 30 is covered with an air electrode side separator 52. The charging electrode side separator 51 and the air electrode side separator 52 are made of an electronically insulating material and prevent a short circuit from being formed by an electron conduction path between those electrodes. For example, the charging electrode side separator 51 and the air electrode side separator 52 can reduce short circuits formed in an event that metal dendrites which are deposited by reduction on the collector 40 during charging reach the charging electrode 11 or the air electrode 21. A solid electrolyte sheet such as a porous resin sheet or an ion exchange film can be used as the charging electrode side separator 51 and the air electrode side separator 52.

The charging electrode side separator 51 in the metal-air battery 1 may be configured to include an anion film. The anion film may contain at least one element selected from the Group 1 through Group 17 of the periodic table, and be made of at least one compound selected from a group consisting of an oxide, a hydroxide, a layered double hydroxide, a sulfuric acid compound, and a phosphoric compound as well as a polymer thereof. The anion film may allow anions such as hydroxide ions to permeate.

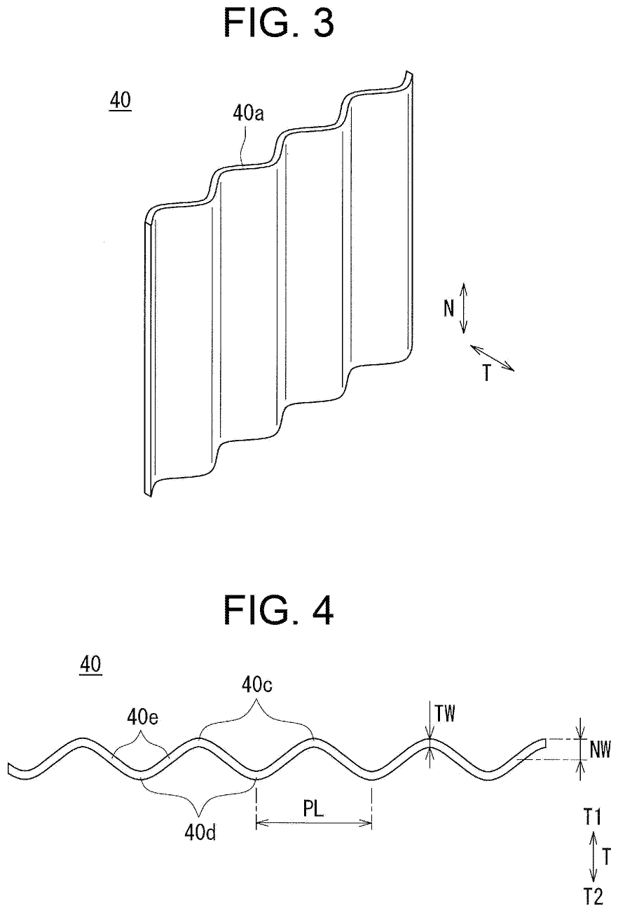

FIG. 2 is an enlarged plan view illustrating the collector of the negative electrode, FIG. 3 is a schematic perspective view of the collector illustrated in FIG. 2, and FIG. 4 is a schematic cross-sectional view of the collector illustrated in FIG. 2. In light of the easiness to see the drawings, FIG. 3 illustrates the collector 40 with through holes 40b being omitted, and FIG. 4 illustrates the collector 40 with the hatching being omitted.

In the present embodiment, the collector 40 may consist of an expanded metal including a plurality of through holes 40b which are surrounded by metal portions 40a extending in a mesh-shaped manner. The collector 40 may be of about 50% porosity, and one opening may be of about 2 mm² area. The method of manufacturing the collector 40 having the through holes 40b is not limited to the present embodiment, and the collector 40 may be manufactured by an etching process, a wire mesh process, or the like.

In the method of manufacturing the collector 40, after performing a step of forming the through holes 40b in a plate, a wave process to bend the plate in a wavy way is performed. By performing the wave process, convex portions (vertices) protruding from one side and the other side in a plate thickness direction T are formed in the collector 40. Hereinafter, for convenience of explanation, a direction in which the convex portions extend (i.e., a wave line direction) may be referred to as wave line direction N. Furthermore, a direction toward one side (upward in FIG. 4) and a direction toward the other side (downward in FIG. 4) in a thickness direction T may be referred to as a first thickness direction Ti and a second thickness direction T2, respectively. For the purpose of distinguishing the convex portions of the collector 40, convex portions protruding in the first thickness direction T1 and convex portions protruding in the second thickness direction T2 may be referred to as upward convex portions 40c and downward convex portions 40d, respectively.

The vertices of the collector 40, which protrude in the thickness direction T (i.e., upward convex portions 40c and downward convex portions 40d), may be formed as curved surfaces. Furthermore, slopes 40e inclined with respect to the thickness direction T may be formed between the upward convex portions 40c and the downward convex portions 40d. According to the vertices with curved surfaces, it is possible to prevent electric field from being locally concentrated as well as suppress current concentration in the active material 31. Thereby, it is possible to suppress a shape change of the active material 31. Moreover, it is possible to further prevent electric field from being locally concentrated because the vertices can be connected to each other via the slopes 40e.

The plate configuring the collector 40 may be 0.1 to 0.2 mm in thickness (plate thickness TW), and in the present embodiment, it is 0.2 mm. The thickness of the entire collector 40 (wave amplitude) may be 0.5 to 1.0 mm, and in the present embodiment, it is 0.5 mm. Namely, a bending height of the collector 40 (i.e., a distance between a center and the vertex in a thickness direction T: wave height NW) may be 0.25 to 0.5 mm, and it is larger than a thickness of the plate (plate thickness TW). A wave processing pitch (a distance between the vertices protruding in the same direction: periodic length PL) may be 1.5 to 3.0 mm, and in the present embodiment, it is 2.0 mm. As described above, because the collector 40 is of a wavy shape structure, deformation of the negative electrode 30 itself is suppressed while flexure during a battery reaction is suppressed, and thus it is possible to obtain stable battery characteristics. The battery characteristics of the metal-air battery 1 will be described together with those of a second and third embodiments below with reference to FIGS. 10 through 12.

### Second Embodiment

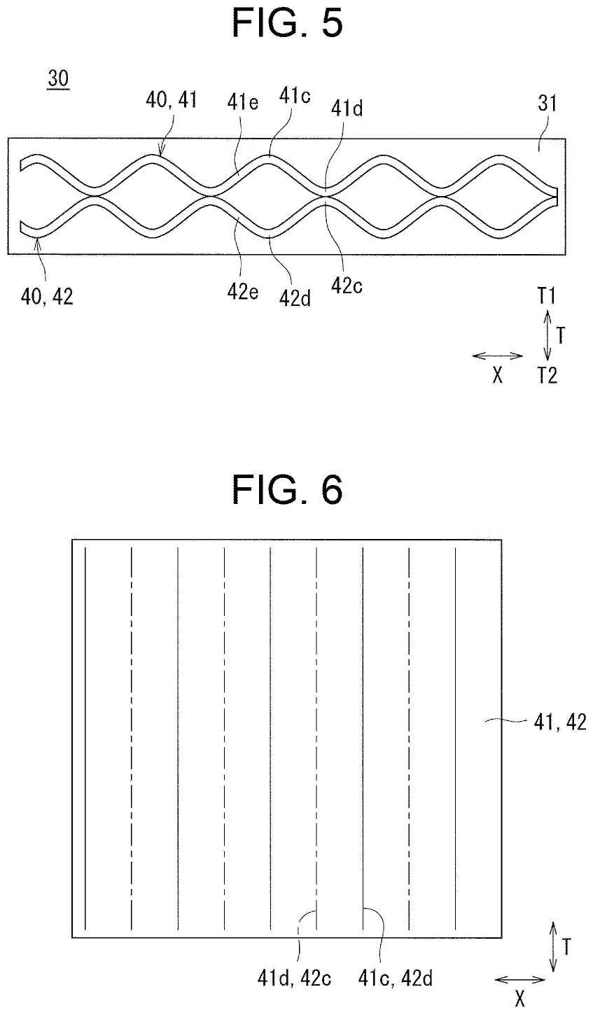

Next, a metal-air battery according to a second embodiment of the present invention will be described with reference to FIGS. 5 and 6. Hereinafter, description and drawings associated with the structure of the metal-air battery according to the second embodiment are omitted because they are similar to the first embodiment.

FIG. 5 is a schematic cross-sectional view of the negative electrode in the metal-air battery according to the second embodiment of the present invention, FIG. 6 is a schematic plan view of the negative electrode illustrated in FIG. 5.

Compared to the first embodiment, the structure of the negative electrode 30 of the second embodiment is different from that of the first embodiment in that the negative electrode includes two collectors 40 regularly stacked in a thickness direction T. For the purpose of distinguishing between the two collectors 40, the collector 40 provided on an upper side in the thickness direction T is referred to as a first collector 41, and the collector 40 provided on a lower side in the thickness direction T is referred to as a second collector 42. By providing the two collectors 40, it is possible to improve the battery performance while increasing a structural strength.

The first collector 41 and the second collector 42 may contact with each other. Specifically, a downward convex portion 41d of the first collector 41 contacts with an upward convex portion 42c of the second collector 42. Because the two collectors 40 contact with each other so that they can support each other, It is possible to increase the structural strength.

The first collector 41 and the second collector 42 are arranged in such a way that the respective wave line directions N are in parallel and the vertices protruding from one collector 40 to the other collector 40 are aligned with each other along the wave line directions N. In FIG. 6, wave lines corresponding to an upward convex portion 41c of the first collector 41 and a downward convex portion 42d of the second collector 42 are shown by solid lines, and wave lines corresponding to the downward convex portion 41d of the first collector 41 and an upward convex portion 42c of the second collector 42 are shown by dashed lines. Furthermore, in FIG. 6, directions along outer edges of the collector 40 are shown as a horizontal direction X and a vertical direction Y, and the wave line directions N of the first collector 41 and the second collector 42 are along the vertical direction Y. As described above, by arranging the two collectors in such a way that the respective wave line directions N are in parallel and the vertices of the collectors 40 face each other, it is possible to further increase the structural strength while maintaining a distance between the collectors 40.

Although the first collector 41 and the second collector 42 contact with each other in the present embodiment, the present invention is not limited thereto. In the third embodiment described below, the first collector 41 may be spaced apart from the second collector 42.

### Third Embodiment

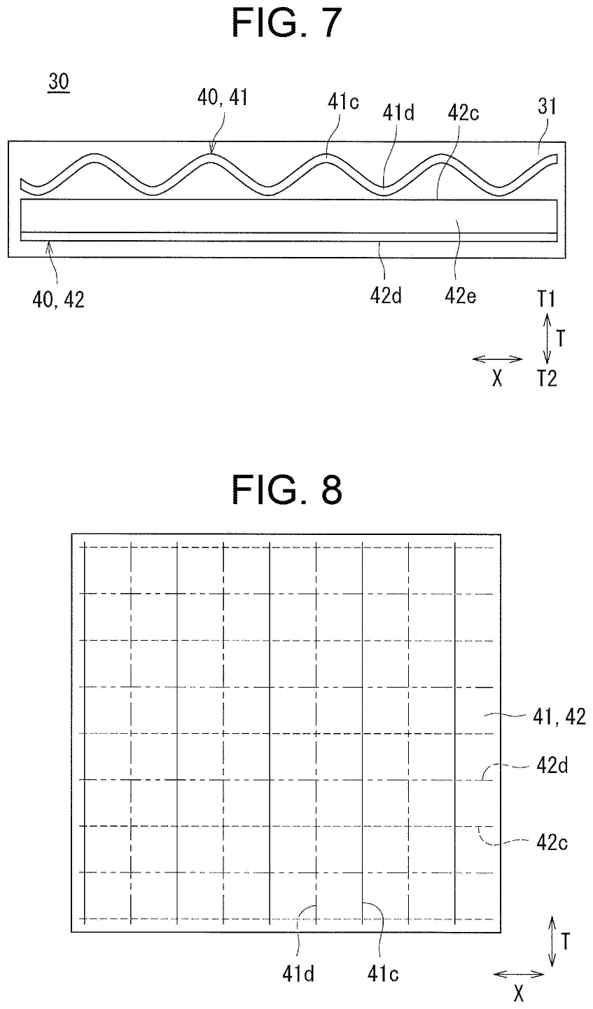

Next, the metal-air battery according to the third embodiment of the present invention will be described with reference to FIGS. 7 and 8. Hereinafter, description and drawings associated with the structure of the metal-air battery according to the third embodiment are omitted because they are similar to the first and second embodiments.

FIG. 7 is a schematic cross-sectional view of the negative electrode of the metal-air battery according to the third embodiment of the present invention, and FIG. 8 is a schematic plan view of the negative electrode illustrated in FIG. 7.

Compared to the second embodiment, an arrangement of the two collectors 40 within the negative electrode 30 in the third embodiment is different from that in the second embodiment. Similar to the two collectors 40 in the second embodiment, the collector 40 provided on an upper side is referred to as the first collector 41, and the collector 40 provided on the lower side is referred to as the second collector 42.

The first collector 41 is spaced apart from the second collector 42. Specifically, a gap is provided between the downward convex portion 41d of the first collector 41 and the upward convex portion 42c of the second collector 42. By providing a gap between the two collectors 40, it is possible to cushion deformation due to expansion of the active material 31.

The wave line directions N of the first collector 41 may respectively cross those of the second collector 42. In FIG. 8, wave lines corresponding to an upward convex portion 41c of the first collector 41 are shown by solid lines, and wave lines corresponding to the downward convex portion 41d of the first collector 41 are shown by dashed lines. Furthermore, wave lines corresponding to an upward convex portion 42c of the second collector 42 are shown by broken lines, and wave lines corresponding to the downward convex portion 42d of the second collector 42 are shown by double-dashed lines. The wave line directions N of the first collector 41 are along the horizontal direction X, and the wave line directions N of the second collector 42 are along the vertical direction Y. As described above, by arranging the two collectors 40 in such a way that the respective wave line directions N cross with each other, it is possible to further increase the structural strength because the wave lines of one collector 40 extend across a plurality of wave lines of the other collector 40.

In the present embodiment, although two collectors 40 are arranged in such a way that the wave lines of the first collector 41 orthogonally cross those of the second collector 42, the present invention is not limited thereto. The wave lines of the first collector 41 may cross those of the second collector 42 at non-right angle.

In the present embodiment, although the first collector 41 and the second collector 42 are spaced apart from each other, the present invention is not limited thereto. Both may contact with each other depending on a relationship between a thickness A of the negative electrode 30 and a layer thickness B of the collectors 40, a value of which is a sum of a layer thickness of the first collector 41 (corresponding to a doubled wave height NW described above) and a layer thickness of the second collector 42 (corresponding to the doubled wave height NW described above).

Specifically, in an example of A<B, the negative electrode 30 is configured by contacting the first collector 41 with the second collector 42. In this configuration, similar to the second embodiment, it is possible to increase the structural strength.

In the zinc-air battery mainly characterized in a large weight energy density, an increased quantity of zinc oxide to be mounted is a trend, whereby an increased thickness of the zinc oxide layer is also trend accordingly. As a result, when the zinc oxide layer is several millimeters in thickness, it is likely to be A>B.

In an example where A>B and the first collector 41 contacts with the second collector 42, the two collectors may be positioned at a center, at a near side of the air electrode 21, or at a near side of the charging electrode 11 in a thickness direction of the negative electrode 30.

In an example where A>B and the first collector 41 and the second collector 42 are spaced apart from each other, it is preferable that the two collectors are disposed at end surfaces of the negative electrode 30, respectively. This configuration makes it easy to maintain the conductivity between the active material in the negative electrode and the collectors when charging and discharging cycles are repeated.

### Method of Manufacturing the Negative Electrode

Next, a method of manufacturing the negative electrode 30 will be described below. When manufacturing the negative electrode 30, a negative electrode active material dispersion solution, which is a basis of the active material 31, is prepared. The negative electrode active material dispersion solution can be produced by mixing zinc oxide particles, pure water, CMC (carbolxymethyl cellulose) being a dispersion stabilizer, and SBR (styrene butadiene rubber) being a binder in a predetermined mass ratio, and stirring the same with a bead mill. Then, a prescribed quantity of the resulting negative electrode active material dispersion solution is poured into a casting cup to which the collector 40 is fixed. After drying the negative electrode active material dispersion solution in an electric furnace at a temperature of 90 degrees Celsius, it is taken out of the casting cap, and then the negative electrode 30 is manufactured by compression molding it with a press machine. In the present embodiment, although an example in which zinc is used as an active material is described, the present invention is not limited thereto. The material may be changed depending on a type of the active material appropriately.

Meanwhile, when drying the negative electrode active material dispersion solution in the electric furnace, the drying near an upper surface of the cup progresses faster than that near a bottom portion of the cup. During this process, a volume of the negative electrode active material dispersion solution near the upper surface is greatly contracted, while a volume of the negative electrode active material dispersion solution near the bottom face is slowly contracted. As a result, stress, which causes the negative electrode 30 to warp toward the upper surface, occurs in the negative electrode 30. Here, in a case where the collector 40 to be a support body of the negative electrode 30 is likely to bend in some direction, deformation can occur in the direction.

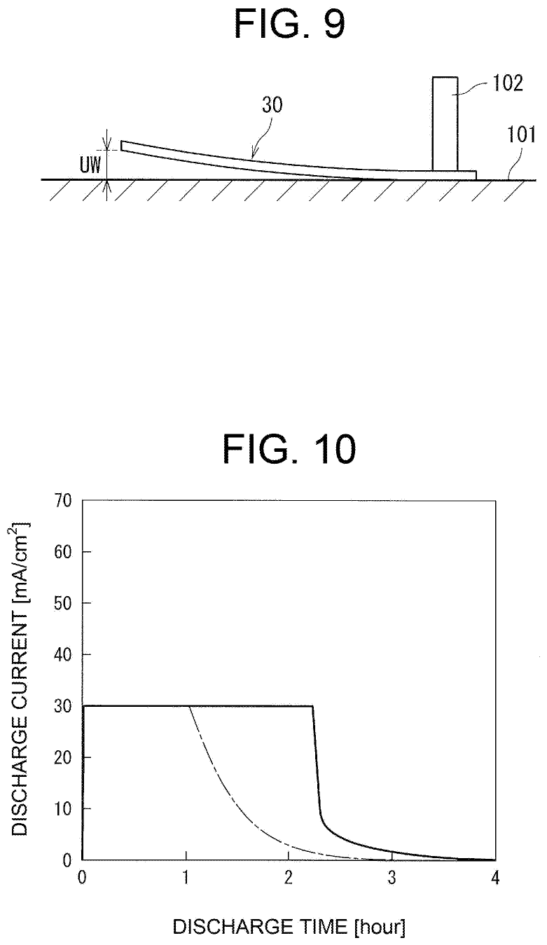

FIG. 9 is a schematic explanatory view illustrating a method of measuring a deformation quantity of the negative electrode during a manufacturing process thereof. In light of the easiness to see the drawings, FIG. 9 illustrates the negative electrode 30 with the deformation quantity being emphasized, but it is different from an actual deformation quantity.

When measuring the deformation quantity of the negative electrode 30, first, the negative electrode 30 is placed on a flat horizontal plane 101, and a weight 102 is placed on one end of the negative electrode 30 to suppress lifting of the negative electrode 30. Then, a height (lifted distance UW), to which the other end of the negative electrode 30 is lifted from the horizontal plane 101, is measured. The lifted distance UW corresponds to the deformation quantity of the negative electrode 30.

In the measurement of the deformation quantity, two kinds of samples, the negative electrode 30 used in the second embodiment and the negative electrode 30 used in the third embodiment, were prepared. These samples are 7×7 cm in size and 1.95 mm in thickness. The measurement resulted in that the deformation quantity of the negative electrode 30 used in the second embodiment was 1.0 to 1.2 mm, and the deformation quantity of the negative electrode 30 used in the third embodiment was 0.2 mm or less.

In the negative electrode 30 made of zinc oxide particles, according to the battery reaction proceeds in the battery, a volume expansion associated with zinc production during charging (deposits of zinc crystals with a low density), or a volume expansion associated with zinc oxide production (volume increase due to oxidation) can occur in the negative electrode 30 facing the charging electrode 11. On the other hand, a presence of zinc oxide facing the air electrode 21 becomes sparse because zincate ions move toward the charging electrode 11 associated with charging. As a result, the collector 40 itself deforms because stress, which forces the collector 40 to protrude toward the air electrode 21, is applied thereto. The deformation of the negative electrode 30 becomes a factor which causes a distance from the surface of the collector 40 to increase and causes a contact resistance to increase due to lowered density, and thus it leads to deterioration of a battery performance such as elevation of charging voltage or drop of discharge voltage.

When stress is applied to the negative electrode 30 itself regardless of whether during a manufacturing process or during the battery reaction, it is possible to suppress deformation of the negative electrode 30 and prevent the battery performance from deteriorating because the negative electrode 30 itself according to the present invention can have a structure to overcome the stress.

### Battery Characteristics

Next, the battery characteristics evaluation results of the metal-air battery 1 will be described below with reference to FIGS. 10 through 12. Hereinafter, for the purpose of easiness to describe, the metal-air battery 1 according to the first embodiment, the metal-air battery 1 according to the second embodiment, and the metal-air battery 1 according to the third embodiment are shortly referred to as a first embodiment, a second embodiment, and a third embodiment, respectively. In the first through third embodiments, samples, whose capacities are changed, even if the collectors are arranged in the same way, by varying the thickness of the negative electrode 30 itself, are appropriately prepared depending on the objects to be compared.

FIG. 10 is a graph showing discharge characteristics of the first embodiment and a comparative example.

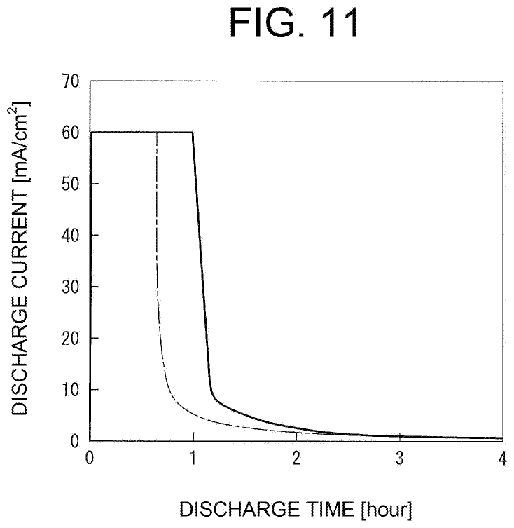

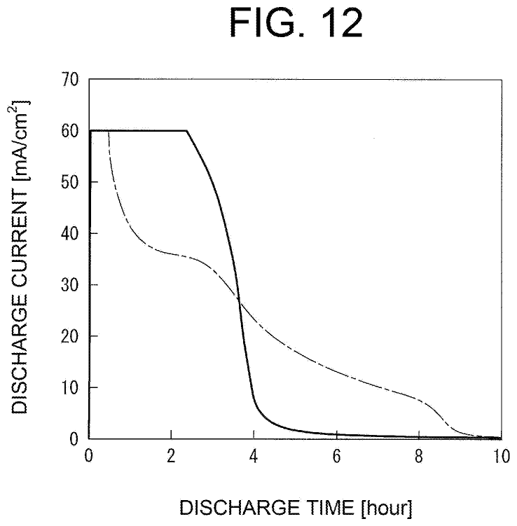

In FIG. 10, the horizontal axis represents a discharge time, and the vertical axis represents a discharge current. Hereinafter, the description of the horizontal and vertical axes is omitted in FIGS. 11 and 12 because it is similar to FIG. 10. Comparative example is different from the first embodiment in a structure of the collector 40. Specifically, the collector of the comparative example is a plate etched metal with 0.2 mm thickness, a shape of the openings is 1.0 mm×1.0 mm square, and a width of each of partitions between the openings is 0.5 mm. The first embodiment in FIG. 10 is a low capacity (2.5 Ah) negative electrode with 0.69 mm thickness. The current-voltage characteristics in an initial state of the first embodiment and the comparative example are measured in advance, and it is confirmed that no difference is therebetween.

In FIG. 10, the discharge characteristics of the first embodiment are shown by a solid line and the discharge characteristics of the comparative example are shown by a dashed line. As illustrated in FIG. 10, as a result of causing the first embodiment and the comparative example to perform CC discharge of 30 mA/cm², the first embodiment shows that the discharge current decreases after the discharge time slightly lapses 2 hours, and the comparative example shows that the discharge current decreases after the discharge time lapses 1 hour. Therefore, it can be seen that the first embodiment is superior in the discharge characteristics to the comparative example.

FIG. 11 is a graph showing discharge characteristics of the first embodiment and the third embodiment.

The current-voltage characteristics in the initial state of the first embodiment and the third embodiment are measured in advance, and it is confirmed that no difference is therebetween. The first embodiment in FIG. 11 is the same as that in FIG. 10. Furthermore, the third embodiment in FIG. 11 is a low capacity negative electrode with 0.8 mm thickness, in which two collectors contact with each other.

In FIG. 11, the discharge characteristics of the third embodiment are shown by a solid line and the discharge characteristics of the first embodiment are shown by a dashed line. As illustrated in FIG. 11, as a result of causing the first embodiment and the third embodiment to perform CC discharge of 60 mA/cm², the first embodiment shows that the discharge current decreases before the discharge time reaches 1 hour, and the third embodiment shows that the discharge current decreases after the discharge time lapses about 1 hour. Therefore, it can be seen that the third embodiment is superior in the discharge characteristics to the first embodiment.

FIG. 12 is a graph showing discharge characteristics of the second embodiment and the third embodiment.

The current-voltage characteristics in the initial state of the second embodiment and the third embodiment are measured in advance, and it is confirmed that no difference is therebetween. In FIG. 12, the second electrode is a high capacity (15 Ah) negative electrode with 1.95 mm thickness, in which two collectors are spaced apart from each other. Furthermore, the third embodiment in FIG. 12 is a high capacity negative electrode with 1.95 mm thickness, in which two collectors are spaced apart from each other.

In FIG. 12, the discharge characteristics of the third embodiment are shown by a solid line and the discharge characteristics of the second embodiment are shown by a dashed line. As illustrated in FIG. 12, as a result of causing the second embodiment and the third embodiment to perform CC discharge of 60 mA/cm², the second embodiment shows that the discharge current decreases before the discharge time reaches 1 hour, and the third embodiment shows that the discharge current decreases after the discharge time lapses 1 hour. Therefore, it can be seen that the third embodiment is superior in the discharge characteristics to the second embodiment.

It should be noted that embodiments disclosed above are exemplary in all respects, and the invention is not limitedly construed on a basis thereof. Therefore, the technical scope of the present invention should not be construed based on only above described embodiments but be defined based on the statement of the claims. Furthermore, those skilled in the art clearly recognize that any modifications or changes within the meaning and scope equivalent to the claims can be encompassed.

What is claimed is:

1. A metal-air battery comprising: an air electrode; and a negative electrode, wherein the negative electrode includes a collector carrying an active material thereon, the collector is formed by bending a plate with through holes in a wavy way, and a bending height of the collector in a thickness direction of the negative electrode is larger than a thickness of the plate.

2. The metal-air battery according to claim 1, wherein vertices of the collector, which protrude in the thickness direction, are formed as curved surfaces.

3. The metal-air battery according to claim 1, wherein the negative electrode includes two collectors regularly stacked in the thickness direction.

4. The metal-air battery according to claim 3, wherein a wave line direction of one collector and a wave line direction of another collector cross with each other.

5. The metal-air battery according to claim 3, wherein directions of the wave lines in the two collectors are arranged in such a way that respective vertices protruding from one collector to another collector are aligned with each other.

6. The metal-air battery according to claim 3, wherein the two collectors are spaced apart from each other.

7. The metal-air battery according to claim 3, wherein the two collectors contact with each other.

8. The metal-air battery according to claim 1 further comprising a charging electrode.
